(19) United States
(12) Patent Application Publication
(10) Pub. No.: US 2020/0344512 A1
(43) Pub. Date: Oct. 29, 2020

(54) COD ASSET INVENTORY DISTRIBUTION ACROSS COD PROVIDERS

(71) Applicant: Canoe Ventures, LLC, Lakewood, CO (US)

(72) Inventors: Jason Canney, Highlands Ranch, CO (US); Steve Markel, Highlands Ranch, CO (US); Timothy R. Whitton, Englewood, CO (US); Bob Griese, Parker, CO (US); Julie Samuelson, Englewood, CO (US); Chris Pizzurro, South Salem, NY (US); Mark Shepard, Denver, CO (US); Yong Liu, Englewood, CO (US)

(21) Appl. No.: 16/927,210

(22) Filed: Jul. 13, 2020

Related U.S. Application Data
(63) Continuation of application No. 14/943,559, filed on Nov. 17, 2015, now abandoned.

(51) Int. Cl. H04N 21/2547; H04N 21/81; H04N 21/234; H04N 21/2668; H04N 21/262

(52) U.S. Cl. CPC H04N 21/2547; H04N 21/812; H04N 21/26241; H04N 21/2668; H04N 21/23424

(57) ABSTRACT

Systems and methods presented herein provide for distributing asset opportunities across COD providers. One system includes an asset load manager (ALM) that receives information from the COD providers about asset opportunities for COD content of the COD providers. The ALM selected asset opportunity and delivers it to a trading platform that offers the asset opportunity to the remaining COD providers. The ALM also receives, from the trading platform, sale information of the asset opportunity to another of the COD providers and information of an asset used to fill the asset opportunity. An asset opportunity information system (AOIS) interfaces with an asset decision system (ADS), to direct the ADS to configure asset rankings and removals according to rules of the second COD provider. The ADS directs an asset insertion into the COD content of the first COD provider based on the asset ranking.

### CROSS REFERENCE TO RELATED APPLICATIONS

This patent application is a continuation patent application claiming priority to, and thus the benefit of an earlier filing date from, U.S. patent application Ser. No. 14/943,559 (filed Nov. 17, 2015). This patent application is also related to commonly owned patent application Ser. Nos. 13/628,324, 13/628,360, and 13/628,381 (each having a filing date of Sep. 27, 2012), the entire contents of each of which are incorporated by reference.

### FIELD OF THE INVENTION

The invention relates to the field of Content On Demand (COD) systems and asset insertions into COD content selections.

### BACKGROUND

Television networks, such as the American Broadcasting Company (ABC), the Columbia Broadcasting Company (CBS), and the National Broadcasting Company (NBC), have for years broadcast television shows to the masses as a means for generating revenue through advertising. For example, these networks produce television shows and then seek out sponsors to advertise on the shows. The television shows, or “content”, have designated timeslots in which the sponsors' advertisements, or “assets”, are inserted. The content and the inserted assets are then broadcast by the television networks, or “content providers”, to the public over federally licensed communication airways, occasionally referred to as linear video distribution.

This “shotgun” approach to advertising proved to be very successful in the beginning. However, as the number of advertisers wishing to sell their goods and services substantially increased, television evolved into a much more complex system of communications. For example, cable television providers and satellite television providers now serve as intermediary content providers between the content providers and the intended public audience. And, the number of content providers has increased accordingly. In this regard, many members of the general public have signed on as customers of the cable/satellite content providers so as to receive a broader availability of content.

Because the market for content consumption has grown, the number of content providers has also grown. And, because each of these providers has its own method of content delivery, the manner in which the content and assets are delivered to the customers has become increasingly complex. Generally, the content providers deliver the content to the content providers with instructions to insert various national assets into the content at certain times. For example, if a company wishes to run a national advertisement campaign targeting a certain television show associated with a particular demographic, the company may purchase one or more timeslots, or “placement opportunities”, within that television show from the content provider to air assets advertising the goods and services of the company. The content provider then provides the content to each of the content providers with directions to insert the assets within the timeslots purchased by the company.

The content providers may also have certain timeslots available for inserting certain local assets. For example, a content provider may have “headends” configured in various communities to distribute content to their customers located therein. Each headend receives content from the content providers with various designated timeslots for inserting assets into the content. Some of those timeslots may be designated for local advertisements where companies within the service area of the headend wish to advertise. These companies purchase those timeslots from the content provider for insertion of their assets to expose the customers to their advertising at the more local level.

As complex as the cable/satellite television has become, certain devices have come along to change and/or circumvent these forms of marketing altogether. The digital recorder, such as that produced by Tivo, is one example of a means for avoiding the asset insertions of marketing strategists. With the digital recorder, the content providers' customers are able to digitally record entire episodes of content and view that content at their leisure, as opposed to a time established by the content providers. However, these customers can also use the digital recorders to fast-forward or skip through the assets without viewing them, much to the dismay of the asset owners.

In response, content providers started providing content on a “Content On Demand” (COD) basis, sometimes referred to as nonlinear video distribution. In COD, the content provider delivers the content to the content provider which in turn maintains the content for subsequent and individual distribution to their customers. Thus, a customer may select a desired content through a set-top box (STB) or other device (collectively referred to herein as “customer premise equipment” or “CPE”) and watch that content at the customer's leisure.

This COD content can also be configured with timeslots where assets may be inserted. For example, an advertiser desiring to place an advertisement in a particular TV show may pay the owner of that TV show (e.g., a content provider such as NBC, ABC, CBS, etc.) to insert their advertisements into one or more the timeslots in the COD content. Once inserted, the asset is delivered in the COD content to a user's CPE.

Occasionally, the owner of the TV show may wish to sell off an asset opportunity to another content provider. For example, in NBC may own a COD TV show with asset opportunities dispersed therein. For any of a variety of reasons, NBC may wish to sell one or more of those asset opportunities to CBS such that CBS can direct the insertion of assets from its advertisers.

### SUMMARY

Systems and methods presented herein provide for distributing asset opportunities across a plurality of COD content providers and/or COD content distributers, collectively referred to herein as COD providers. In one embodiment, a system includes an asset load manager (ALM) operable to interface with the COD providers, to receive information from the COD providers about asset opportunities for COD content of the COD providers, to select a first of the asset opportunities from a first of the COD providers, and to deliver the first asset opportunity to a trading platform that offers the first asset opportunity to the remaining COD providers. The first asset opportunity comprises demographic information intended for the COD content and the ALM is further operable to receive, from the trading platform, sale information of the first asset opportunity to a second of the COD providers and information of an asset used to fill the first asset opportunity. The system also includes an asset opportunity information system (AOIS) operable to interface with an asset decision system (ADS), to direct the ADS to configure asset rankings and removals according to rules of the second COD provider. The ADS directs an asset insertion into the COD content of the first COD provider based on the asset ranking.

The various embodiments disclosed herein may be implemented in a variety of ways as a matter of design choice. For example, the embodiments may take the form of physical machines, computer hardware, software, firmware, or combinations thereof. In one embodiment, a computer readable medium is operable to store software instructions for directing the asset insertion into content. These software instructions are configured so as to direct a processor or some other processing system to operate in the manner described above. Other exemplary embodiments are described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary system for distributing asset opportunities across a plurality of COD providers.

FIG. 2 is a flowchart of an exemplary process operable with the system of FIG. 1.

FIG. 3 is a block diagram of an exemplary asset inserter operable with a COD system.

FIG. 4 is a block diagram of an exemplary timing diagram of a COD content selection with asset placement opportunities.

FIG. 5 is a block diagram of an exemplary COD asset decision system.

FIG. 6 is another block diagram of an exemplary system for distributing asset opportunities across a plurality of COD providers.

FIG. 7 is a message diagram operable with the systems herein.

FIG. 8 is a block diagram of an exemplary processing system operable to distribute asset opportunities across a plurality of COD providers.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below.

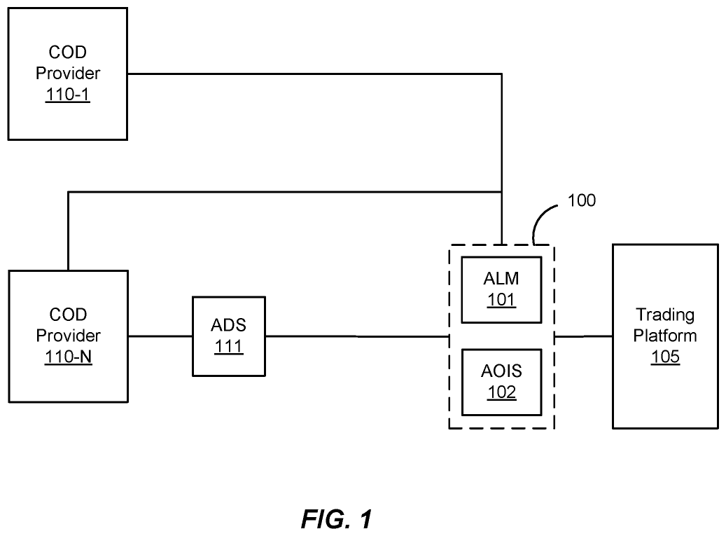

FIG. 1 is a block diagram of a system 100 for distributing asset opportunities for a plurality of COD providers 110-1-110-N (wherein the reference “N” is merely intended to represent an integer greater than “1” and not necessarily equal to any other “N” reference designated herein). For example, each content provider 110 may have COD content with timeslots available for asset insertions (e.g., advertisement insertions). When the content providers 110 desire to offer their timeslots to other content providers, the system 100 processes those asset opportunities and makes them available to a trading platform 105, which in turn sells the asset opportunities to other content providers.

The system 100 includes an asset load manager (ALM) 101 and an asset opportunity information system (AOIS) 102. The ALM 101 processes the asset opportunities from the content providers 110 and delivers them to the trading platform. The ALM 101 also processes information from the trading platform pertaining to the sales of the asset opportunities. The AOIS 102 processes the sale information and directs an asset decision system (ADS) 111 as to how assets should be inserted into the COD content. For example, the ADS 111 may comprise campaign data and asset mappings (e.g., configured as a data structure) that determine how certain assets should be inserted into COD content. The ADS 111, on a COD content by COD content basis, may determine how assets are inserted into the COD content. The ADS 111 may then direct the content provider 110 to insert the assets according.

The ALM 101 and the AOIS 102 may be configured in a variety of ways as a matter design choice. For example, the system 100 may be a network element, such as a computer network server, operable to interface with a variety of components through the Internet or another computer network. In this regard, the ALM 101 and the AOIS 102 may be computer modules operable within the system 100. Thus, the system 100 (and its components, the ALM 101 and the AOIS 102) is any device, software, or combination thereof operable to interface between content providers 110 and a trading platform 105 to process asset opportunities for sale via the trading platform 105.

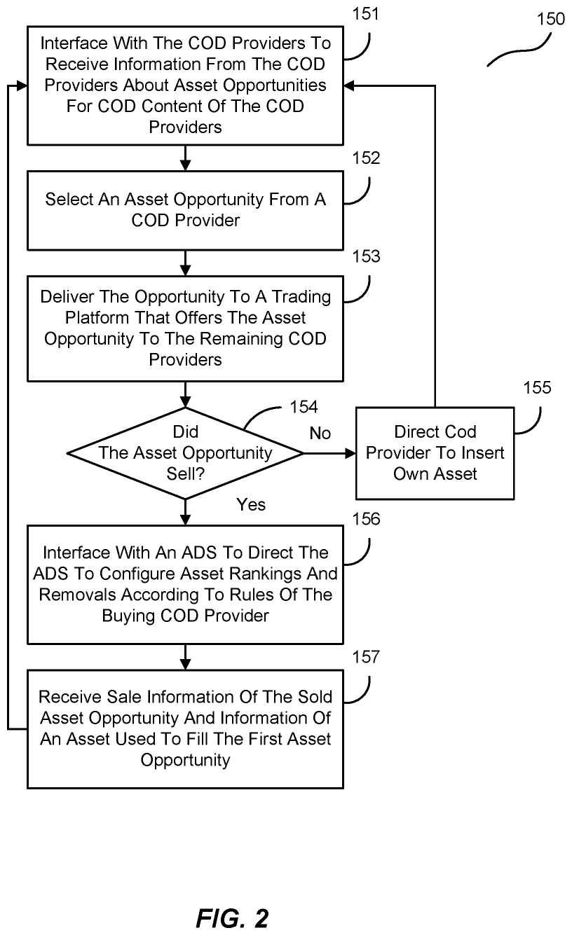

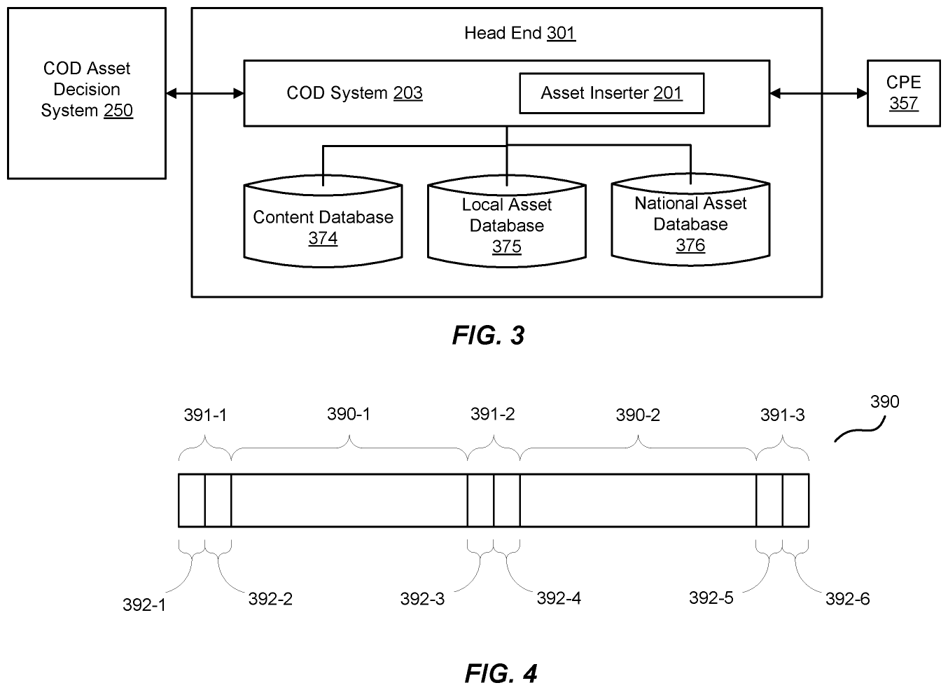

The ADS 111 is operable to process asset campaign information for a plurality/variety of assets to recommend insertions for those assets into COD content by the COD providers 110. The ADS 111 may also be implemented in a variety of ways as a matter of design choice. One example of how the ADS 111 can be implemented is shown and described with the COD ADS 250 in FIGS. 3 and 4. Additional details regarding the operation of the system 100 are now shown and described with the process 150 of FIG. 2.

In FIG. 2, the process 150 initiates with the ALM 101 interfacing with the COD providers 110-1-110-N and receiving information from the COD providers 110 about asset opportunities for their COD content, in the process element 151. The ALM 101 then selects asset opportunities of the COD providers, in the process element 152, and delivers the opportunity to the trading platform 105 to offer the asset opportunity to another of the COD content operators, in the process element 153. For example, the ALM 101 may continuously monitor the COD providers 110 to determine whether any of the COD providers 110 desires to offer any of their timeslots of their respective COD content to other content providers 110. When the ALM 101 receives information that a COD provider 110 wishes to sell a timeslot, the ALM 101 presents that asset opportunity to trading platform 105 to the other remaining content providers 110 via the trading platform 105 to see if those remaining content providers 110 wish to purchase the asset opportunity.

The ALM 101 then determines whether the asset opportunity sold, in the process element 154. For example, the trading platform 105 will convey information regarding the sale or non-sale of the asset opportunity to the ALM 101. If the asset sells, the ALM 101 will pass the sale information of the purchased asset to the AOIS 102.

If the asset is sold, the AOIS 102 directs the ADS 111 to configure asset rankings and removals according to rules of the buying COD provider 110, in the process element 156. For example, any given content provider 110 may interact with the ADS 111 such that the ADS 111 determines which assets should be inserted into the various COD content selections available from the content providers 110. As part of this process, a user through his CPE 357 may select a COD content of a COD provider 110 which in turn notifies the ADS 111 of the content selection, providing asset information such as genre, time of day, date, expected demographic of the viewer, etc. to the ADS 111. The ADS 111 then searches the asset campaigns of the content provider 110 to select assets that should be inserted into that COD content selection. In doing so, the ADS 111 excludes certain assets from insertion based on rules of that COD provider 110 and then ranks the remaining available assets to provide the COD provider 110 with a list of assets for insertion into the selected COD content. However, once an asset opportunity of a COD provider 110 is sold to another COD provider 110, the rules and asset mappings of the other COD provider are then applied, thereby transforming the asset opportunity's parameters to that of the purchasing COD provider 110.

To illustrate, suppose the COD provider 110-1 offers an asset insertion opportunity to the trading platform 105 through the ALM 101. And then the trading platform 105 sells the asset opportunity to the content provider 110-N. Previously, any asset being inserted into the COD content selection of the COD provider 110-1 would have had the asset campaign rules of the COD provider 110-1 applied via the ADS 111. Since the purchasing COD provider 110-N now has the asset opportunity of the COD provider 110-1, the AOIS 102 directs the ADS 111 to apply the asset campaign rules of the COD provider 110-N.

Thereafter, the sale information pertaining to the asset opportunity is conveyed to the ALM 101 such that the AOIS 102 may process the sale information and convey it to the selling content provider 110-1, in the process element 157. In addition to the sale information, the ALM 101 receives and processes information pertaining to the actual asset inserted into the sold asset opportunity. For example, once the ADS 111 ranks and selects the assets according to the buying COD provider 110's rules, information pertaining to the inserted asset(s), such as intended demographic, date, time, etc., are conveyed to the COD provider 110 such that it may update its rules for removing and ranking assets.

If the asset opportunity does not sell (process element 154), then the AOIS 102 directs the selling COD provider to insert its own asset, in the process element 155. Again, this may include directing the ADS 111 to exclude and rank assets according to the asset campaign rules of the selling COD provider 110. Additional details regarding the ADS 111 are shown and described below in the ADS 250.

FIG. 3 is a block diagram of an exemplary COD ADS 250 operable with a COD system 203 (also known as a “COD back office system”) of a headend 301. The ADS 250 illustrates one example of how the ADS 111 may operate. The headend 301, in this embodiment, is generally any system operable to receive content for processing and distribution to a CPE 357 (e.g., over a cable television infrastructure or from satellite). For example, the headend 301 may receive content from content providers over television signals for distribution to the customers of a cable content provider via the customer premise equipment (CPE) 157, such as a set-top box (STB), a gaming console, a smart phone, an electronic tablet, a computer, or the like.

The COD system 203 of the headend 301 provides the COD content to the CPE 357 when desired by the customer. For example, the headend 301 may receive the content from the content providers and maintain that content within a content database 374. The headend 301 may also maintain local assets in a local asset database 375 and national assets in a national asset database 376. When a particular content is selected by the user of the CPE 357, an asset inserter 201 of the COD 203 accesses the content database 374 to retrieve the selected content and deliver that content to the CPE 357.

The COD 203 is any system or device that is operable to deliver video content to the CPE 357 when directed by the CPE 357. The databases 374, 375, and 376 are any systems or devices operable to store and maintain data, audio, and/or video for subsequent distribution to the CPE 357. For example, the databases 374, 375, and 376 may be operable within a computer system that stores the video and audio (e.g., MPEG) content and assets such that they may be accessed by the COD 203 and delivered to the CPE 357 when desired by the user of such.

To illustrate the insertion of assets into content, FIG. 4 shows an exemplary timing diagram of content 390 interlaced with asset timeslots 391, also known as “break positions”. When the COD 203 receives a message from the CPE 357 for the content 390, the COD 203 retrieves the content 390 from the content database 374. The content 390, in this embodiment, is divided into two segments 390-1 and 390-2 with timeslots 391 disposed at the front end of the content 390-1 (i.e., timeslot 391-1 at the pre roll position), in between the content segments 390-1 and 390-2 (i.e., timeslot 391-2 at the mid roll position), and at the end of the content segment 390-2 (i.e., timeslot 391-3 at the post roll position). Each timeslot 391 is divided into two asset placement timeslots 392 (i.e., asset placement opportunities), each of which is capable of accepting an asset that is typically, but not always, 30 seconds in duration. Thus, a placement opportunity is generally a subset of time of a particular timeslot 391. The COD asset decision system 250 directs the COD 203 to insert the assets according to a particular ranking that provides value for the content provider (e.g., monetary value, enhanced relationships with asset providers, etc.). In this regard, the COD asset decision system 250 may direct the COD 203 to select assets from the national asset database 106 and/or the local asset database 375 for insertion into the asset timeslots 392-1-392-6 based on the ranking provided by the COD asset decision system 250.

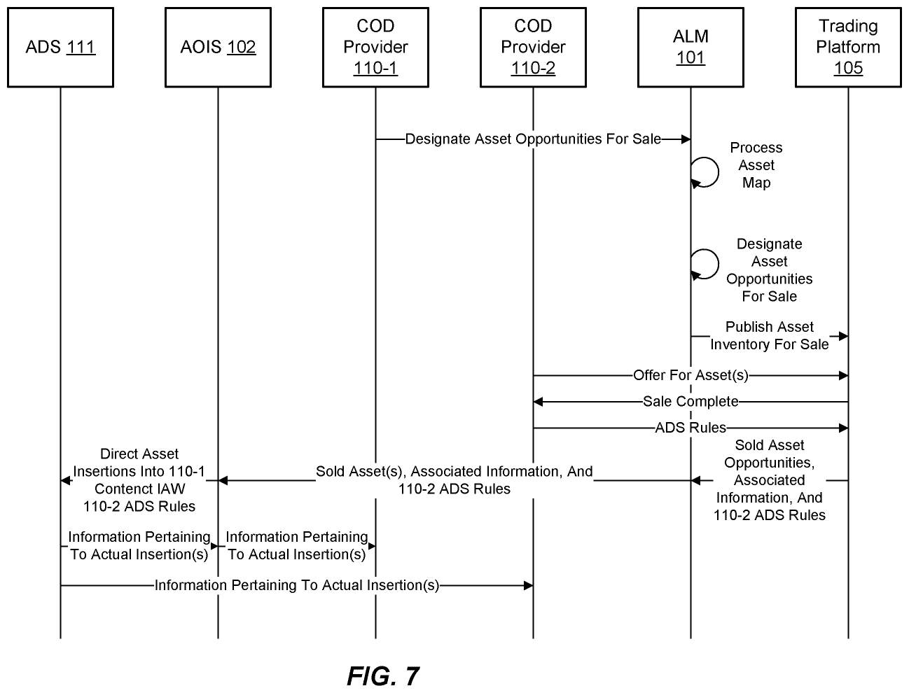

Also, the invention is not intended be limited to any particular number of content segments 390 or any particular number of asset timeslots. In fact, an asset timeslot 392 may be subdivided for insertion of multiple assets. For example, television commercials are typically 30 seconds in length. Occasionally, however, asset providers reduce the material of certain assets to reduce the overall duration of a particular asset (e.g., by removing material from a 30 second commercial to reduce it to a 15 second commercial). Accordingly, a 30 second asset timeslot 392 may be configured to accept insertions of two 15 second assets. For example, in FIG. 7, the content 390 may be configured with the mid roll timeslot 391-2 having two 30 second asset timeslots 392-3 and 392-4. The asset timeslot 392-3 can thus be further divided into two 15 second asset timeslots 392-3-1 and 392-3-2, allowing for the insertion of two 15 second assets into the asset timeslot 392-3. Still, the invention is not intended to be limited to any particular asset duration, asset timeslot 392 duration, or timeslot 391 duration as such may be configured to meet certain business and/or technical needs.

It should be noted that the decisions regarding the direction of asset insertions occur quite rapidly. For example, the COD asset decision system 250 may be operable to make asset insertion decisions for a plurality of headends 301. And, each headend 301 may be operable to provide COD content to a plurality of CPE 357 at any given time, possibly thousands or more. Thus, when a COD content selection is made by a particular CPE 357, the COD asset decision system 250 responds in substantially real time to ensure that the COD 203 has ample time to retrieve and insert the assets while processing the content selected by the CPE 357.

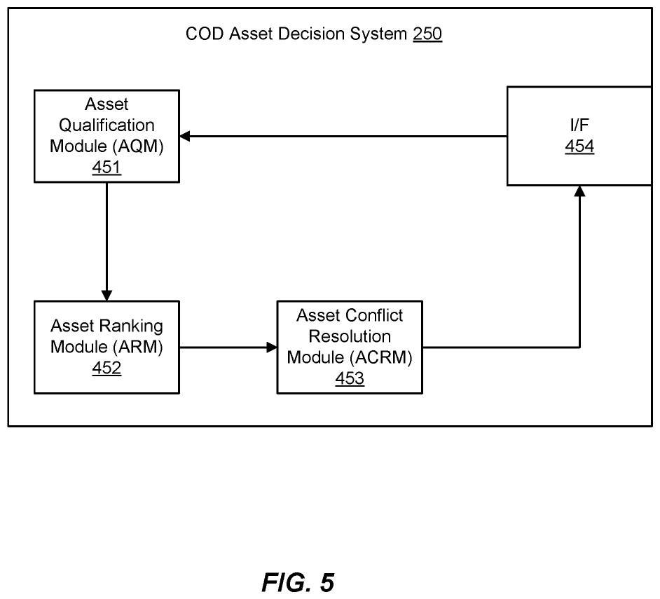

FIG. 5 is a block diagram of an exemplary COD asset decision system 250. In this embodiment, the COD asset decision system 250 includes an interface 454, an asset qualification module (AQM) 451, an asset ranking module (ARM) 452, and an asset conflict resolution module (ACRM) 453. The interface 454 is any device or system operable to receive information pertaining to a content selection by a CPE 357 such that the COD asset decision system 250 may direct asset insertion into the selected content. In this regard, the interface 454 may also be operable to transfer information to the COD 203 to direct the COD system 203 to insert certain assets from the national asset database 376 and/or the local asset database 375.

The AQM 451 is any device or system operable to communicate with the interface 454 to initially qualify assets for insertion within the content. The AQM 451 may exclude certain assets from insertion into the content selected by the CPE 357. The ARM 452 is any device or system operable to rank the remaining assets (i.e., those not already excluded by the AQM 451) for insertion to the content 390. The ACRM 453 is any device or system operable to remove any ranked assets from insertion into the content 390 based on conflicts between assets. For example, the ACRM 453 may determine that assets from certain advertisers conflict with one another (e.g., Coke and Pepsi). Accordingly, the ACRM 453 may be operable to prevent assets from these advertisers from being inserted within a same timeslot 391 or even within a same content 390. The exemplary operations of the AQM 451, the ARM 452, and the ACRM 453 are explained in greater detail below.

The COD asset decision system 250 is any system, device, software, or combination thereof operable to interface with a plurality of asset providers to process information about assets (e.g., advertisements, marketing materials, etc.) of the asset providers such that the COD asset decision system 250 can direct a content provider to insert assets from the asset providers into COD content selected by a CPE 357. For example, the content provider may have access to content from a plurality of content providers (described in greater detail below) that the content provider provides to its customers via their respective CPE 357. In this regard, the content provider may include a COD system 203 that retrieves stored content for presentation to a CPE 357 when selected by a user of the CPE 357. The content provider may also have access to assets that are to be inserted into asset placement timeslots (i.e., asset placement opportunities) within the content. The COD asset decision system 250, being operable to provide value to the content providers, coordinates with campaigns of the asset providers to extract value for the content providers. In this regard, the COD asset decision system 250 may rank the assets of the asset providers in a manner that provides the most value to the content providers.

CPEs 357 are any devices or systems capable of providing content to users. For example, a CPE 357 may be a set-top box operable to communicate with a cable television headend. Alternatively, a CPE 357 can be a computer or a mobile computing device capable of displaying video from a network (e.g., via streaming video over the Internet). For example, a CPE 357 may select a desired content from an Internet website hosted with an internet server (i.e., a content provider and COD system 203) through the network. Once selected, the COD system 203 may retrieve the content from a content database for Internet delivery to the selecting CPE 357. The COD ADS 250, being communicatively coupled to the COD system 203, processes information pertaining to the content selection and selects assets for insertion into that content from a national asset database and/or a local asset database, as illustrated in FIG. 3. To provide more context to the operations of the COD asset decision system 250, the following example is provided.

In this example, a CPE 357 selects a particular episode of the television show “30 Rock” at 8 pm on a Thursday night from a menu of COD content that is presented by the COD 203. The COD 203 retrieves that episode of 30 Rock from the content database 374. The COD 203 then retrieves certain assets from the national asset database 376 for insertion into the timeslots of that show. As with many other 30 minute situational comedies, this episode of 30 Rock includes two content sections 390-1 and 390-2 and the three timeslots 391-1, 391-2, and 391-3, as illustrated in FIG. 7. Using this example, the COD 203 transfers an asset insertion request to the AQM 451 to insert assets into these three timeslots. The AQM 451 then determines that there are a total of six 30 second asset placement opportunities within three timeslots 391-1-3 of the selected content 390. The AQM 451 then processes the active campaigns to determine their eligibility within those six 30 second asset placement opportunities. Among the active campaigns in this example are:

1. A Coca-Cola campaign with a total of four assets and 3 campaign items directing placement opportunities of those assets as follows:

a) Asset 1 for 100 views anytime;

b) Asset 2 for any viewing opportunities Monday through Friday between the hours of 5 pm and 10 pm; and

c) Assets 3 and 4 for any viewing opportunities Friday and Saturday between the hours of 5 pm and 10 pm.

2. A Pepsi-Cola campaign with a total of five assets and four campaign items directing placement opportunities of those assets as follows:

a) Asset 1 for 20 views anytime;

b) Asset 2 for 100 views anytime;

c) Asset 3 for 1000 views anytime;

d) Asset 4 for any viewing opportunities Monday through Friday between the hours of 5 pm and 10 pm; and

e) Asset 5 for any viewing opportunities Friday and Saturday between the hours of 5 pm and 10 pm.

3. A Capital One credit card campaign with a total of four assets and three campaign items directing placement opportunities of those assets as follows:

a) Asset 1 for 100 views anytime;

b) Asset 2 for 1000 views anytime; and

c) Assets 3 and 4 for any viewing opportunities Monday through Friday between the hours of 5 pm and 10 pm.

4. A Chrysler Motors campaign with a total of three assets and two campaign items directing placement opportunities of those assets as follows:

a) Asset 1 for 100 views; and

b) Assets 2 and 3 for any viewing opportunities Monday through Friday between the hours of 5 pm and 10 pm.

5. A Nickelodeon campaign with one asset and one campaign item directing placement opportunities of that asset as follows:

a) Asset 1 for 100 views.

Since the television show 30 Rock has a mature theme and since the Nickelodeon campaign is directed towards a younger audience, that campaign item is automatically excluded from the eligible campaign list by the AQM 451. Other remaining campaign items are excluded based on time and date (i.e., campaign items 1c and 2e).

Thus the remaining campaigns of 1a-1b, 2a-2d, 3a-c, 4a-4b are transferred to the ARM 452 for ranking. Based on various factors explained in greater detail below, the ARM 452 ranks the campaigns as follows:

1. Campaign Item 2a

2. Campaign Item 1a

3. Campaign Item 3c

4. Campaign Item 2b

5. Campaign Item 4b

6. Campaign Item 4a

7. Campaign Item 1b

8. Campaign Item 1d

9. Campaign Item 2c

10. Campaign Item 1c

11. Campaign Item 2d

12. Campaign Item 3a

13. Campaign Item 3b

The ARM 452 transfers this ranked list of campaign items to the ACRM 453 to determine conflicts within the ranked list of campaign items. Typically, the six available asset placement opportunities 392-1-6 within the content 390 would be filled by the first six campaign items based on a rank determined by the ARM 452. However, since some conflicts may exist between campaigns within a particular content and/or timeslot, certain campaigns may be excluded from the placement opportunities 392 such that the ranking is reordered. For example, certain criteria may dictate that a Pepsi Cola asset may not be placed within the same content as a Coca-Cola asset. In this regard, the campaign items 1a-1d are removed from the ranked list because the Pepsi-Cola asset has the higher initial ranking, leaving the following campaign items:

1. Campaign Item 2a

2. Campaign Item 3c

3. Campaign Item 2b

4. Campaign Item 4b

5. Campaign Item 4a

6. Campaign Item 2c

7. Campaign Item 2d

8. Campaign Item 3a

9. Campaign Item 3b

With this computed, the ACRM 453 may remove the final three campaign items 7, 8, and 9 from the list as the six placement opportunities can be filled with assets. The ACRM 453 then transfers this information regarding asset placement to the COD 203.

Once all of the campaign items at each campaign have been evaluated and no campaigns remain or once all of the placement opportunities have been filled, the ACRM 453 directs the COD 203 to retrieve the assets based on the list generated. For example, the list may be included in a report message that is transferred to the COD 203 to direct the COD 203 to insert the assets into the content selected by the CPE 357. It is possible that all of the assets have been excluded during the processes described herein. Thus, the ACRM 453 may then direct the COD 203 to not place any assets in the content selected by the CPE 457.

The ACRM 453 may even direct the COD 203 to place assets from the local database 375 and/or the national database 376 into the selected COD content as desired. The ACRM 453 may also direct the COD 203 to place assets relating to content, programming, or even services provided by the content provider. For example, if no assets remain, standard programming information, such as time and date, pertaining to the selected COD content may be configured as an asset and placed in the selected COD content. To further illustrate, when an episode of “Modern Family” is selected by a CPE 357 and no assets remain for insertion into the available time slots of that episode, the ACRM 453 may direct the COD 203 to present the user of the CPE 357 with the date and time when the next episode of Modern Family can be seen.

Since it is also possible that not all of the assets in the list may be placed as there may be more assets than available opportunities, the ACRM 453 may weight the assets prior to placement in the selected COD content. For example, certain assets may provide greater value to the content provider (e.g., the television network). In this regard, the ACRM 453 may rank the remaining assets in a manner that provides the most monetary compensation to the content provider. Thus, the ACRM 453 may reduce the list of available assets for insertion to the amount of opportunities, or timeslots, in the selected COD content to provide this value to the content provider. In any case, the ACRM 453 directs the COD 203 to place the assets in the selected COD content based on the ranked list. Once placement has been directed, the ACRM 453 generates a placement report and transfers that report to the headend 301 so that the headend 301 can track marketing views (e.g., for later negotiations between content providers and marketers). For example, when a marketer can know how many views of a particular asset there were in a selected COD content, the marketer can assign a value to that asset that may be used in negotiating price for additional views of the asset in future selected COD content.

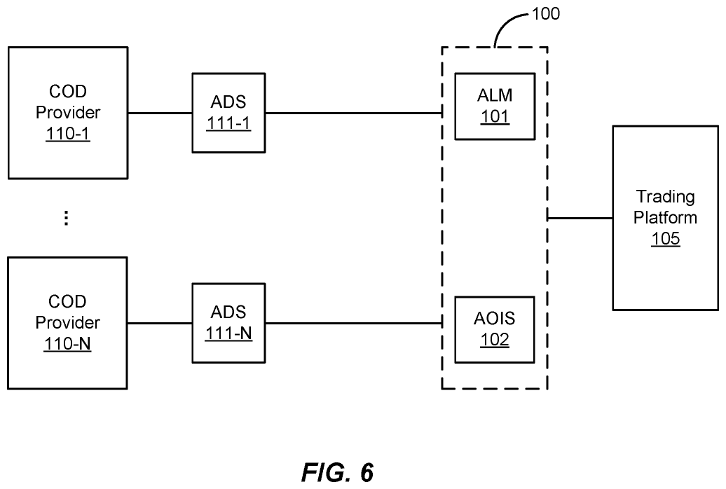

FIG. 6 is another block diagram of an exemplary system 100 for distributing asset opportunities across a plurality of COD providers 110-1-110-N. In this embodiment, each COD provider 110 has its own ADS 111 that is operable to direct the insertion of assets into the COD provider 110's COD content, as described above. Accordingly, when one COD provider 110 sells an asset opportunity to another COD provider to the trading platform 105, the system 100 transfers information pertaining to the sale to the selling COD provider 110's ADS 111. In this regard, the system 100 also conveys information as to how the sold asset opportunity should be inserted based on the ADS of the purchasing COD provider 110.

To illustrate, the COD provider 110-1 offers an asset opportunity to the system 100. The ALM 101 as described above transfers the asset opportunity to the trading platform 105. Then, another COD provider 110-N buys the asset opportunity. The trading platform 105 transfers the sale information to the AOIS 102, which in turn releases sale information to the COD provider 110-1.

Additionally, the AOIS 102 transfers information pertaining to how the assets should be inserted into the content provided by the COD provider 110-1. This directed insertion is implemented based on rules developed by the ADS 111-N. For example, the ADS 111-N determines which assets are best suited for insertion into content provided by the COD provider 110-1. As these asset opportunities of the COD provider 110-1 have been purchased by the COD provider 110-N, the ADS 111-N now determines which assets are best suited for insertion into the content provided by the COD provider 110-1 as if the content is being provided by the COD provider 110-N.

Once the ADS 111-N directs insertion of assets into the content provided by COD provider 110-1, information pertaining to those insertions is conveyed to the COD provider 110-N as well as the COD provider 110-1 so that the COD provider 110-1 may learn more effective strategies for asset insertions into its own content.

FIG. 7 is a message diagram operable with the systems herein. In this embodiment, a COD provider 110-1 designates an asset opportunities for sale and provides that information to the ALM 101. The ALM 101 then processes an asset map that links to multiple COD content asset opportunities. For example, the COD provider 110-1 may have a large number of asset opportunities it wishes to sell in any number of COD content selections by users of CPEs 357. The COD provider 110-1 may provide this information in the form of a map that shows when and where assets are to be inserted into the available asset opportunities. The ALM 101 designates these asset opportunities for sale and publishes them to the trading platform 105.

Once within the trading platform 105 other COD providers 110 may make offers to purchase the assets. For example, the COD provider 110-2 may make an offer for all or a portion of the asset opportunities available from the COD provider 110-1. In this example, the trading platform 105 may complete the sale for the asset opportunities selected by the COD provider 110-2. If the COD provider 110-2 did not purchase all of the asset opportunities being offered by the COD provider 110-1, the ALM 101 may continue to publish the remaining asset opportunities to the trading platform 105 until they are sold or until the COD provider 110-1 designates them as being no longer for sale.

After the sale is complete, the COD provider 110-2 transfers the ADS rules to the trading platform 105 which in turn relays the sold asset opportunities, any associated information, and the ADS rules of the COD provider 110-2 (e.g., from the ADS 111-2 associated with the COD provider 110-2 or some other central ADS 111) to the ALM 101. The ALM 101 relays this information to the AOIS 102 which directs the ADS 111 to insert assets into the purchased asset opportunities in accordance with the ADS rules of the COD provider 110-2.

After the assets are inserted into the content provided by the COD provider 110-1, information pertaining to it the actual insertions is conveyed to the COD provider 110-1 and/or the COD provider 110-2. This allows the COD providers 110 to reconfigure their asset campaigns to improve asset decision by the ADS 111. More particularly, the COD providers 110 may convey this information to their respective asset managers which allows them to reconfigure their asset campaigns that subsequently direct assets to be inserted into COD content selections by the COD providers 110 after being vetted by the ADS 111.

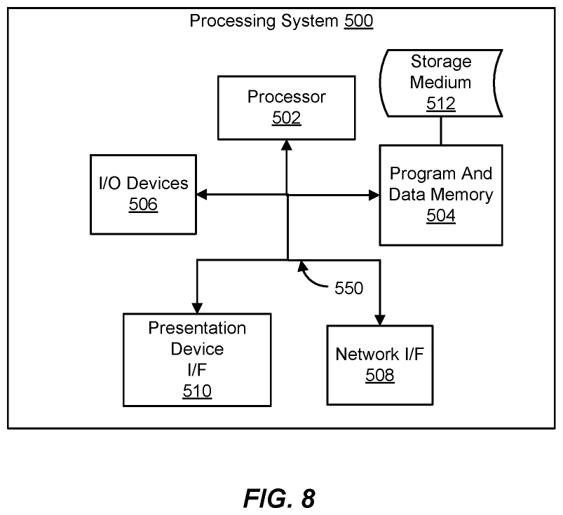

FIG. 8 is a block diagram depicting a processing system 500 also operable to provide the above features by executing programmed instructions and accessing data stored on a computer readable storage medium 512. In this regard, embodiments of the invention can take the form of a computer program accessible via the computer-readable medium 512 providing program code for use by a computer or any other instruction execution system. For the purposes of this description, computer readable storage medium 512 can be anything that can contain, store, communicate, or transport the program for use by a computer.

The computer readable storage medium 512 can be an electronic, magnetic, optical, electromagnetic, infrared, or semiconductor device. Examples of computer readable storage medium 512 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

The processing system 500, being suitable for storing and/or executing the program code, includes at least one processor 502 coupled to memory elements 504 through a system bus 550. Memory elements 504 can include local memory employed during actual execution of the program code, bulk storage, and cache memories that provide temporary storage of at least some program code and/or data in order to reduce the number of times the code and/or data are retrieved from bulk storage during execution.

Input/output (I/O) devices 506 (including but not limited to keyboards, displays, pointing devices, etc.) can be coupled to the processing system 500 either directly or through intervening I/O controllers. Network adapter interfaces 508 may also be coupled to the system to enable the processing system 500 to become coupled to other processing systems or storage devices through intervening private or public networks. Modems, cable modems, IBM Channel attachments, SCSI, Fibre Channel, and Ethernet cards are just a few of the currently available types of network or host interface adapters. Presentation device interface 510 may be coupled to the system to interface to one or more presentation devices, such as printing systems and displays for presentation of presentation data generated by the processor 502.

While the invention has been illustrated and described in detail in the drawings and foregoing description, such illustration and description is to be considered as exemplary and not restrictive in character. Certain embodiments described hereinabove may be combinable with other described embodiments and/or arranged in other ways. Accordingly, it should be understood that only the preferred embodiment and variants thereof have been shown and described and that all changes and modifications that come within the spirit of the invention are desired to be protected.

Additionally, although the term “headend” generally suggests the distribution center or office of a cable television operator or MSO, the term is not intended to be so limited. The term headend as used herein is any system operable to deliver content to a viewer (e.g., a customer or user of the CPE). For example, the term headend may encompass satellite content providers that offer COD content and/or Internet services to its subscribers. That content is typically delivered directly to the subscriber's antenna for demodulation and decryption by the subscriber's CPE 357. Internet traffic in such a system may be conveyed by satellite and/or other delivery mechanisms (e.g., digital subscriber lines, or “DSL”, delivered through subscriber phone lines).

A headend may also refer to a telecom provider that distributes content to mobile phones and other devices. Also, the term “asset”, as used herein, includes any type of media for which an owner desires promotion. Examples of such include traditional television commercials, advertisements, streaming video commercials, promotional materials, marketing information, and the like. The term “content”, as used herein, is any type of media, such as audio and/or video, in which assets may be inserted. For example, the content operable within the COD delivery systems described herein may be streamed Internet audio/video, analog cable television feeds, digital cable television feeds, digital satellite television feeds, or digital satellite radio feeds. Thus, the content of the COD described herein is intended to encompass Video on Demand (VOD) and pay-per-view (PPV) delivered by both modern cable television and satellite television.

What is claimed is:

1. A system operable to distribute asset opportunities across a plurality of content on demand (COD) providers, the system comprising:
an asset load manager (ALM) operable to interface with the COD providers, to receive information from the COD providers about asset opportunities for COD content of the COD providers, to select a first of the asset opportunities from a first of the COD providers, and to deliver the first asset opportunity to a trading platform that offers the first asset opportunity to the remaining COD providers,
wherein the first asset opportunity comprises demographic information intended for the COD content, and
wherein the ALM is further operable to receive, from the trading platform, sale information of the first asset opportunity to a second of the COD providers and information of an asset used to fill the first asset opportunity; and
an asset opportunity information system (AOIS) operable to interface with an asset decision system (ADS), to direct the ADS to configure asset rankings and removals according to rules of the second COD provider,
wherein the ADS directs an asset insertion into the COD content of the first COD provider based on the asset ranking.

2. The system of claim 1, wherein:
the ADS is operable with the first COD provider; and
the AOIS is further operable to interface with an ADS of the second COD provider.

3. The system of claim 1, wherein:
the ALM is further operable to determine a number of impressions for the first asset opportunity, and to present the number of impressions with the first asset opportunity to the trading platform.

4. The system of claim 1, wherein:
the ALM is further operable to process sale price information of the first asset opportunity; and
the AOIS is further operable to direct the first COD provider to update a value associated with first asset opportunity based on the sale price information.

5. The system of claim 1, wherein:
the information of the asset used to fill the first asset opportunity includes a genre of the COD content, an intended demographic for the COD content, and a date and time when the asset was used to fill the first asset opportunity.

6. A method for distributing asset opportunities across a plurality of content on demand (COD) providers, the method comprising:
interfacing with the COD providers to receive information from the COD providers about asset opportunities for COD content of the COD providers;
selecting a first of the asset opportunities from a first of the COD providers;
delivering the first asset opportunity to a trading platform that offers the first asset opportunity to the remaining COD providers, wherein the first asset opportunity comprises demographic information intended for the COD content;
receiving, from the trading platform, sale information of the first asset opportunity to a second of the COD providers and information of an asset used to fill the first asset opportunity; and
interfacing with an asset decision system (ADS) to direct the ADS to configure asset rankings and removals according to rules of the second COD provider,
wherein the ADS directs an asset insertion into the COD content of the first COD provider based on the asset ranking.

7. The method of claim 6, wherein:
the ADS is operable with the first COD provider; and
the method further comprises interfacing with an ADS of the second COD provider.

8. The method of claim 6, further comprising:
determining a number of impressions for the first asset opportunity; and
presenting the number of impressions with the first asset opportunity to the trading platform.

9. The method of claim 6, further comprising:
processing sale price information of the first asset opportunity; and
directing the first COD provider to update a value associated with first asset opportunity based on the sale price information.

10. The method of claim 6, wherein:
the information of the asset used to fill the first asset opportunity includes a genre of the COD content, an intended demographic for the COD content, and a date and time when the asset was used to fill the first asset opportunity.

11. A non-transitory computer readable medium comprising instructions that, when executed by a processor, direct the processor to distribute asset opportunities across a plurality of content on demand (COD) providers, the instructions further directing the processor to:
interface with the COD providers to receive information from the COD providers about asset opportunities for COD content of the COD providers;
select a first of the asset opportunities from a first of the COD providers;
deliver the first asset opportunity to a trading platform that offers the first asset opportunity to the remaining COD providers, wherein the first asset opportunity comprises demographic information intended for the COD content;
receive, from the trading platform, sale information of the first asset opportunity to a second of the COD providers and information of an asset used to fill the first asset opportunity; and
interface with an asset decision system (ADS) to direct the ADS to configure asset rankings and removals according to rules of the second COD provider,
wherein the ADS directs an asset insertion into the COD content of the first COD provider based on the asset ranking.

12. The computer readable medium of claim 11, wherein:
the ADS is operable with the first COD provider; and
the method further comprises interfacing with an ADS of the second COD provider.

13. The computer readable medium of claim 11, the instructions further directing the processor to:
determine a number of impressions for the first asset opportunity; and
present the number of impressions with the first asset opportunity to the trading platform.

14. The computer readable medium of claim 11, the instructions further directing the processor to:
process sale price information of the first asset opportunity; and
direct the first COD provider to update a value associated with first asset opportunity based on the sale price information.

15. The computer readable medium of claim 11, wherein:
the information of the asset used to fill the first asset opportunity includes a genre of the COD content, an intended demographic for the COD content, and a date and time when the asset was used to fill the first asset opportunity.
